(19) United States
(12) Patent Application Publication
(10) Pub. No.: US 2015/0242545 A1
(43) Pub. Date: Aug. 27, 2015

(54) Method of Simulation of Moving Interfaces using Geometry-Aware Volume of Fluid Method

(71) Applicants: Junghyun Cho, Seoul (KR); Hyeong-Seok Ko, Seoul (KR)

(72) Inventors: Junghyun Cho, Seoul (KR); Hyeong-Seok Ko, Seoul (KR)

(21) Appl. No.: 14/187,099

(22) Filed: Feb. 21, 2014

(51) Int. Cl. G06F 17/50; G06F 17/10

(52) U.S. Cl. CPC G06F 17/5009; G06F 17/10

(57) ABSTRACT

A method for simulating moving interface in viscous incompressible two phase flows is provided by conservation of the fluid volume and a detailed reconstruction of the fluid surface using sub-grid refinement of the level set with the volume-of-fluid method.

### RELATED APPLICATION

This application is a non-provisional application corresponding to Provisional U.S. Patent Application Ser. No. 61/767,696 for “Method of Simulation of Moving Interfaces using Geometry-Aware Volume of Fluid Method” filed on Feb. 21, 2013.

### Incorporation by Reference

The Provisional U.S. Patent Application Ser. No. 61/767,696 and all the reference papers are incorporated by reference into this disclosure as if fully set forth herein.

### SUMMARY OF INVENTION

A method of simulation of moving interfaces using geometry-aware volume-of-Fluid method is provided. The method comprises steps for:

representing two different fluid volumes in a domain using a level set surface on a grid mesh comprising a plurality of cells;

representing an interface with a zero contour of a level set function;

modeling two phase flow dynamics of the two different fluid volumes using a viscous incompressible Navier-Stokes equations with surface tension;

updating incompressible velocity field of the domain by computing a velocity advection term in a conservative manner, performing a velocity diffusion implicitly, performing a pressure projection with surface tension, and applying a pressure difference to make an intermediate velocity incompressible;

updating the interface using the incompressible velocity field by updating a volume fraction of each cell in a conservative manner, moving the level set interface using a semi-Lagrangian method, correcting a resulting level set interface according to the volume fraction, and performing redistancing of the level set; and

displaying the updated interface of the two fluid volumes on a display,

wherein the level set values are stored in refined sub-grids,

wherein in order to correct level set values in a cell to be consistent with the volume fraction a sub-cell volume element is generated and used.

The viscous incompressible Navier-Stokes equations with surface tension may comprise

$$\begin{matrix}\text{?} & Eq . 1 \\ \text{?} & Eq . 2 \\ \text{?} & Eq . 3 \\ \text{?} , & Eq . 4 \\ \text{?} \text{indicates text missing or illegible when filed} & \end{matrix}$$

where u, ρ, μ, p, D, σ, κ, δₛ, n, and g stand for velocity, density, dynamic viscosity, pressure, deformation rate tensor, surface tension coefficient, curvature, Dirac delta function defined on the interface, unit normal to the interface, and gravity, respectively, T is a volume fraction, and φ is the level set, wherein 0≦T≦1.

The method may further comprising steps for:

computing the density and the dynamic viscosity using

$$\begin{matrix}\text{?} & Eq . 5 \\ \text{?} & Eq . 6 \\ \text{?} \text{indicates text missing or illegible when filed} & \end{matrix}$$

and computing the curvature using

$$\begin{matrix}\text{?} . & Eq . 7 \\ \text{?} \text{indicates text missing or illegible when filed} & \end{matrix}$$

The grid mesh may comprise a restrictive and fully-threaded octree.

The method may further comprise a step for integrating time using a modified fractional step method (FSM) such as

[symbol] FIG. 3

where the superscript n+½ denotes a time step right after the step of updating the interface, F is a linear operator, and G is a weighted Laplace operator produced by the pressure projection,

wherein the linear systems represented by F and G are solved by using a Poisson equation solver.

The method may further comprise a step for coupling the level set and the volume fraction by a volume computation such as a Heaviside function approximation formulas.

An advection of the volume fraction may be performed by Eq. 3, which is discretized by Eq. 11,

$$\begin{matrix}\text{?} & Eq . 11 \\ \text{?} \text{indicates text missing or illegible when filed} & \end{matrix}$$

wherein Eq. 11 is integrated by Eqs. 12 and 13 for two (2)-dimensional domain

$$\begin{matrix}\text{?} & Eq . 12 \\ \text{?} . & Eq . 13 \\ \text{?} \text{indicates text missing or illegible when filed} & \end{matrix}$$

After the advection of the volume advection an advection of the level set may be performed by a semi-Lagrangian method such as a Runge-Kutta second-order method.

In correcting the level set values in a cell to be consistent with the volume fraction all the level set values in the refined cell are changed by a constant c of Eq. 14,

$$\begin{matrix}\text{?} , & Eq . 14 \\ \text{?} \text{indicates text missing or illegible when filed} & \end{matrix}$$

wherein the constant c for a given target volume fraction T is determined by a Brent's method.

A center position of the sub-cell volume element may be determined by computing an inverse distance weighted average of level set points.

The advection of the volume fraction may further comprise a volume correction given by

[symbol] Algorithm 1.

The redistancing may be performed by computing a signed distance directly from meshes extracted from the level set grid.

### BRIEF DESCRIPTION OF DRAWINGS

The patent or application file contains at least one drawing executed in color. Copies of this patent or patent application publication with color drawing(s) will be provided by the Office upon request and payment of the necessary fee.

These and other features, aspects and advantages of the present invention will become better understood with reference to the accompanying drawings, wherein:

FIG. 1 shows an air ring develops into deforming bubbles simulated by the proposed method, GAVOF, with a resolution of 192×192×64.

FIG. 2 shows a solver architecture according to an embodiment of the invention.

FIG. 3 shows a time integration step according to an embodiment of the invention.

FIG. 4(a) shows an interface obtained with the level set values of the black dots without refinement.

FIG. 4(b) shows an interface obtained with the level set values of the black dots within the current cell with refinement.

FIG. 4(c) shows a refined point shared with neighbor cells shown in red.

FIG. 5 shows a volume fraction of the cell in red, updated by FVM (in x-direction), L and R represent the fluxes passing through the left and right faces, and they are approximated by the Heaviside function.

FIG. 6(a) shows a level, set volume correction cases where the level set is fitted to the volume fraction.

FIG. 6(b) shows a volume fraction indicating that flotsam exists or a small feature is aliased in the cell and since the volume fitting may result in undesired interface, the sub-cell volume element (shown in red) is generated.

FIG. 6(c) shows another typical case of the level set volume correction, in which the volume fitting is unnecessary.

FIG. 6(d) shows another case of level set volume correction, in which the level set is fitted to have the same sign with the minimum distance and the dashed line is expected to be the resulting interface.

FIG. 7(a) shows sample points for the curvature computation at the center of the shaded cell in 2D.

FIG. 7(b) shows sample points for the curvature computation at the center of the shaded cell in 3D.

FIG. 8 shows four columns of water with different thicknesses. Plateau-Rayleigh instability from the surface tension is naturally reproduced, the resolution is 128̂3.

FIG. 9 shows volume profiles, in which the volume is well preserved in all the experiments: lines (a1) and (a2) showing water and air volume in the air-ring simulation; line (b) showing ne water volume in the simulation of four columns of water; line (c) showing the water volume in the surface tension simulation; and line (d) showing the water volume in the water-drop simulation, where the volume scales for the solid and dashed lines are shown in the left and right axes, respectively.

FIG. 10 shows water drops in 3D, in which various scales of bubbles are naturally simulated, where the resolution is 128̂3.

FIG. 11 shows close-up shots of the final GAVOF simulation in which a 6 cm wide cubic water inside the 30 cm wide domain deforms by the surface tension. The resolution is 32̂3, in which using single core, each time step took about one second, and in this simulation, a Taubin's smoothing filter is applied to local meshes with parameters λ=0.5 and kPB=0.05 [Tau95].

FIG. 12 compares the results of the vortex deformation test, showing that the proposed method preserves the deformed shape and volume quite well.

### DETAILED DESCRIPTION EMBODIMENTS OF THE INVENTION

We present a new framework to simulate moving interfaces in viscous incompressible two phase flows. The goal is to achieve both conservation of the fluid volume and a detailed reconstruction of the fluid surface. To these ends, we incorporate sub-grid refinement of the level set with the volume-of-fluid method. In the context of this refined level set grid we propose the algorithms needed for the coupling of the level set and the volume-of-fluid, which include techniques for computing volume, redistancing the level set, and handling surface tension. We report the experimental results produced with the proposed method via simulations of the two phase fluid phenomena such as air-cushioning and deforming large bubbles.

Categories and Subject Descriptors (according to ACM CCS): I.3.5 [Computer Graphics]: Computational Geometry and Object Modeling Physically Based Modeling I.3.7 [Computer Graphics]: Three-Dimensional Graphics and Realism-Animation

### 1. Introduction

Fluid flows are attractive natural phenomena. Imagine large air bubbles entrapped in a volume of water which are stretching, breaking, and merging as they interact with the water. For a quarter of a century, many researchers in the computational science field have tried to grasp the beautiful behaviours of fluids. In the field of computer graphics, reproduction of two phase flows in which both liquid and gas media exist has been a practical challenge.

A two phase flow simulator, generally, consists of two main components: the solver of the fluid momentum as described by Navier-Stokes equations and the tracker of the fluid interface. Conservation of the physical quantities (such as the momentum and the volume) is important for both components. However, there is a trade-off; as the velocity field becomes sophisticated, it is hard to obtain the interface to conserve the volume. Given that the interface is directly related to the visualization quality, it is a seminal issue in the computer graphics community.

Eulerian and Lagrangian approaches have been applied to both components. Eulerian approaches with the fractional step method (FSM) as the momentum solver and the level set method (LSM) as the interface tracker have been a popular choice. However, with the LSM, it is known that the results tend to be diffusive. Moreover, the fluid volume is not preserved. Hybrid methods which incorporate the LSM with Lagrangian objects such as particles or explicit meshes can reduce the volume loss. However, volume conservation is not sufficiently guaranteed when using particles for scenes with small features. The local volume transfers and topology changes are still difficult to handle with methods that use explicit meshes in spite of the recent remarkable advances in this area. In terms of volume conservation, the Eulerian volume-of-fluid. (VOF) method and the Lagrangian smoothed particle hydrodynamics (SPH) method have clear advantages. Unfortunately, these methods pose the challenge of extracting smooth interfaces, which is not the case in the level set based methods.

The above discussion leads us to revisit the classical method of combining the level set and the VOF methods. In this paper, we develop a new framework to couple the level set and the VOF methods to achieve both conservation of the fluid volume and a detailed reconstruction of the fluid surface. In contrast to previous coupling methods, we use refined sub-grids to store the level set. Since the level set of the refined sub-grid is used to know the geometric situation of the given volume fraction, it can effectively handle sub-cell level details and local volume transfers. We refer to this method as the geometry-aware volume-of-fluid (GAVOF) method. The contributions of this paper can be summarized as follows: (1) The paper introduces a new framework, GAVOF, to couple the level set and the VOF methods with geometrical consistency. (2) It develops algorithms needed for the implementation of GAVOF, which include redistancing the level set and handling surface tension. (3) It shows by experiments that the proposed method does preserve both the volume and the details quite well.

### 2. Related Work

The global framework of the proposed method is based on the Eulerian scheme. But Lagrangian meshes are also used in each local cell. Thus, we review both Eulerian and Lagrangian methods which are relevant to our work.

### 2.1. Eulerian Methods

The LSM [OS88] and the VOF method [HN81] based on the FSM [Cho67, Sta99] are commonly used Eulerian methods. In the LSM, the interface is defined by the zero contour of the level set function. The discrete level set representation can lose the signed distance property as the interface evolves, thus, a redistancing procedure is needed to maintain the signed distance property [SSO94]. During the processes of surface evolution and redistancing, the volume can disappear or become aliased. To alleviate such problems, methods using a sub-cell fix [RS00] for the redistancing, using particles [EMF02, ZB05, SKK07], using adaptive grids [LGF04, HK10], and using filters [KLL*07, KSK09] have been introduced. However, those methods do not conserve the local volume to a sufficient degree in scenes with small features.

Recently, methods that are mainly focusing on the conservations have been introduced; [MMTD07] has suggested a density based interface tracking method; [LGF11, LCPF12], have presented conservative semi-Lagrangian advection methods; [CM12] has combined the previous two types of methods. Especially, the methods [LCPF12, CM12] for liquids showed very efficient results by allowing large time steps. Our work takes a different approach from them; in our work two phase flows are solved without the free surface approximation; the volume is conserved via the VOF method. Although our method depends on small time steps, realistic viscous bubbles can be achieved.

The VOF method guarantees conservation of the volume. The interface is generally reconstructed by means of the piecewise linear interface calculation (PLIC) [RK98]. However, it is not connected across the cells of the grids. Therefore, if low-resolution grids are used, it becomes difficult to capture the sub-cell features and obtain the mesh for rendering. The time restriction is also stiffer than that of the LSM. To increase the level of detail in the interface and reduce the degree of freedom of the domain, a method using an adaptive grid (Gerris) [Pop03] has been introduced. To solve the disconnected interface problem, a method combining the level set and the VOF method (CLSVOF) [SP00] and applications such as [MUM*06, KPNS10] have also been introduced. Our work carries on the ideas of Gerris and CLSVOF, but extends it to the sub-cell level.

### 2.2. Lagrangian and Hybrid Methods

Methods based on SPH [Mon92] as well as hybrid methods that combine the Lagrangian particles or meshes with the Eulerian grids have been increasingly introduced. Since the early works [PTB*03, MCG03] on SPH, improvements in the incompressibility [BT07, SP09], in the adaptivity [APKG07, SG11], and in the versatility [AIA*12, IAAT12, CPPK07] have been made. Along with the above improvements on the SPH itself, techniques to convert particles into a smooth interface also have been developed by [YT10, YWTY12]. Despite the recent remarkable advances, however, SPH methods are less accurate in modeling the interfacial viscosity and the surface tension of two phase flows. Space-filling particles may have to be used to solve multi-phase flows accurately.

Hybrid methods have been introduced to complement the Eulerian and Lagrangian methods. The particle level set (PLS) based methods [EMF02, SKK07] and the fluid implicit particle (FLIP) based methods [ZB05, AT11, BB12] have shown impressive results. For small-scale bubbles and forms interacting with large-scale fluids, methods to couple the SPH and PLS methods [HLYK08, LTKF08], methods to couple the SPH and the marker level set (MLS) methods [MMS09], and a method to use stochastic particles [KSK10] also have been introduced. Recently, mesh-based methods have been actively studied by [BGOS06, M0″ 9, WTGT09, WTGT10, TWGT10, BBB10]. However a purely mesh based simulator is still difficult to implement. To alleviate the difficulties associated with handling the topological changes and balancing the interfacial forces, the meshes are often embedded to the Eulerian grids. The fluid volume is then offset in a global manner. This contrasts to our method, in which the meshes are readily available in each local cell and the fluid volume is compensated for locally.

### 3. The System Overview

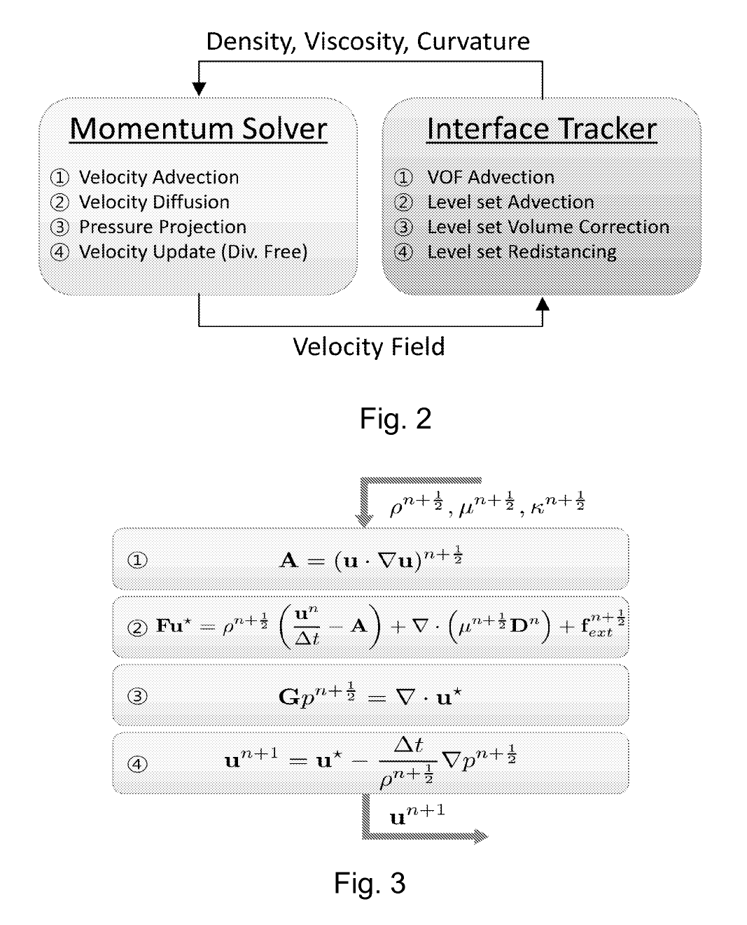

In this section we give an overview of our framework, deferring the details and the contributions of our method in the next two sections (Sections 4 and 5). FIG. 2 shows the solver architecture, which consists of two main components: the momentum solver and the interface tracker. If a good momentum solver has been already equipped, the interface tracker could be easily implemented.

Given the density, dynamic viscosity, and the curvature in each grid cell, the momentum solver updates the velocity of the domain as follows: (1) the solver computes the velocity advection term in a conservative manner. (2) The solver performs the velocity diffusion implicitly. (3) The solver performs the pressure projection with the surface tension. (4) Finally, the solver applies the pressure difference to make the intermediate velocity incompressible. Two phase fluid flows can be approximated by single phase fluid flows with the free surface boundary. Although such approximation can reduce the amount of computation, lack of the pressure of the counterpart can cause the moving interfaces to collapse. Therefore, in the development of the momentum solver, we did not make the free surface approximation.

From the incompressible velocity field given by the momentum solver, the interface tracker updates the interface as follows: (1) the tracker updates the volume fraction of each cell in a conservative manner. (2) The tracker moves the level set interface using a semi-Lagrangian method. (3) The tracker corrects the resulting level set interface according to the volume fraction. (4) Finally, the tracker performs redistancing of the level set. The conserved volume fractions are a primary component for the momentum solver. The level set values are continuously corrected to fit the volume fraction. In the process of volume correction of the level set, inconsistency between the volume fraction and the level set may occur. We will describe this problem in more detail and propose a solution in Section 5, which forms the main contribution of this paper.

### 4. The Momentum Solver

In this section, we briefly describe the momentum solver. Although it is not the main contribution in this paper, we emphasize that the incompressibility of the velocity field is important to conserve the fluid volume aside from the prevention of the interface aliasing. Also, the momentum conservation is important to preserve sub-cell level details. Hence, we use the finite volume method (FVM) strictly to solve the momentum equations. For more details for the momentum solver, we recommend to refer to Gerris [Pop03].

### 4.1. Governing Equations

We solve the viscous incompressible Navier-Stokes equations with surface tension.

∇·u=0 (1)

ρ(u₁+·∇u)=−∇p'∇·(2μD)+σκδₛn+g (2)

₁+·(Tu)=0 (3)

φ+∇·(φu)=0 (4)

where u, ρ, μ, p, D, σ, κ, δₛ, n, and q are the velocity, the density, dynamic viscosity, the pressure, the deformation rate tensor, surface tension coefficient, the curvature, the Dirac delta function defined on the interface, the unit normal to the interface, and the gravity, respectively. T (0≦T≦1) is the volume fraction and φ is the level set. Equations 1 and 2

[symbol]

describe the incompressibility of the velocity field and the conservation of the momentum, respectively. Equation 3 is the advection of the volume fraction and describes the conservation of the mass if we define the density by the volume fraction. Equation 4 is the advection of the level set, which is supplemented for the interface tracking.

The density and dynamic viscosity are computed from the volume fraction according to Equations 5 and 6, and the curvature is computed from the level set as Equation 7 (Section 5.7). For two phase flows at high density/viscosity ratio, the filtered volume fraction is generally used.

$$\begin{matrix}ρ = T {ρ}_{1} + ( 1 - T ) {ρ}_{2} & ( 5 ) \\ μ = T {μ}_{1} + ( 1 - T ) {μ}_{2} & ( 6 ) \\ κ = ∇ \cdot ( \frac{∇ φ}{‖ ∇ φ ‖} ) & ( 7 )\end{matrix}$$

### 4.2. Spatial Discretization

To reduce degrees of freedom and efficiently determine where the fluid interfaces exist, we use an octree grid. Various interpolation schemes on the octree grid have been suggested [Pop03, LGF04, MG07]. We adopt the restrictive and fully-threaded octree of [Pop03], which facilitates the implementation of the multigrid solver (Section 4.4) and the pre-computation of ENO coefficients (Section 5.6). All variables except for the level set are stored at the center of the grid cells. This simplifies the FVM formulation. The velocity-pressure decoupling problem caused by the collocated arrangement is moderated by solving the pressure projection at the face center (not at cell center).

### 4.3. Time Integration

The time integration is done with the modified FSM which is illustrated in FIG. 3.

The superscript n+¹ a denotes the time step right after the interface tracker. The spatial derivatives of the equations in each step are discretized by FVM. In particular, the velocity advection term is discretized by Bell-Galena-Graz (BCG) second order unsplit scheme [BCG89], which is known to be stable when the CFL number is less than one. The velocity diffusion is computed by the Crank-Nicolson method. The resulting Helmholtz type equation produces a linear operator F. The pressure projection produces the weighted Laplace operator G. The linear systems represented by F and G can be solved by using the Poisson solver.

### 4.4. Poisson Equation Solver

To solve linear systems in Section 4.3 efficiently, we use the multigrid method, which requires us to formulate Gauss-Seidel relaxation operator for the Poisson equation. To do this, we integrate Equation 8 over a cell.

[symbol]

where e is a variable and r is a right hand side. By applying the divergence theorem, we have Equation 9.

$${\sum }_{d} {▽}_{d} e = hr \qquad ( 9 )$$

where ∇_{d} is the gradient operator at the face in a direction d and h is the cell size. By linearizing the gradient operator,

[symbol]

Gauss-Seidel relaxation is fulfilled by Equation 10.

$$e = \frac{hr - {\sum }_{d} {β}_{d}}{{\sum }_{d} {α}_{d}} \qquad ( 10 )$$

where α_{d} and β_{d} are the slope and the intercept of the linearized gradient operator in a direction d. The relaxation for the residual equation is directly applied to each level of grids using V-cycle. We use simple averaging and straight injection for the restriction and prolongation operators. The result after V-cycles corrects the error and enhances the convergence substantially.

### 5. Geometry-Aware VOF

In this section, we present our geometry-aware interface tracker.

### 5.1. Cell Refinement

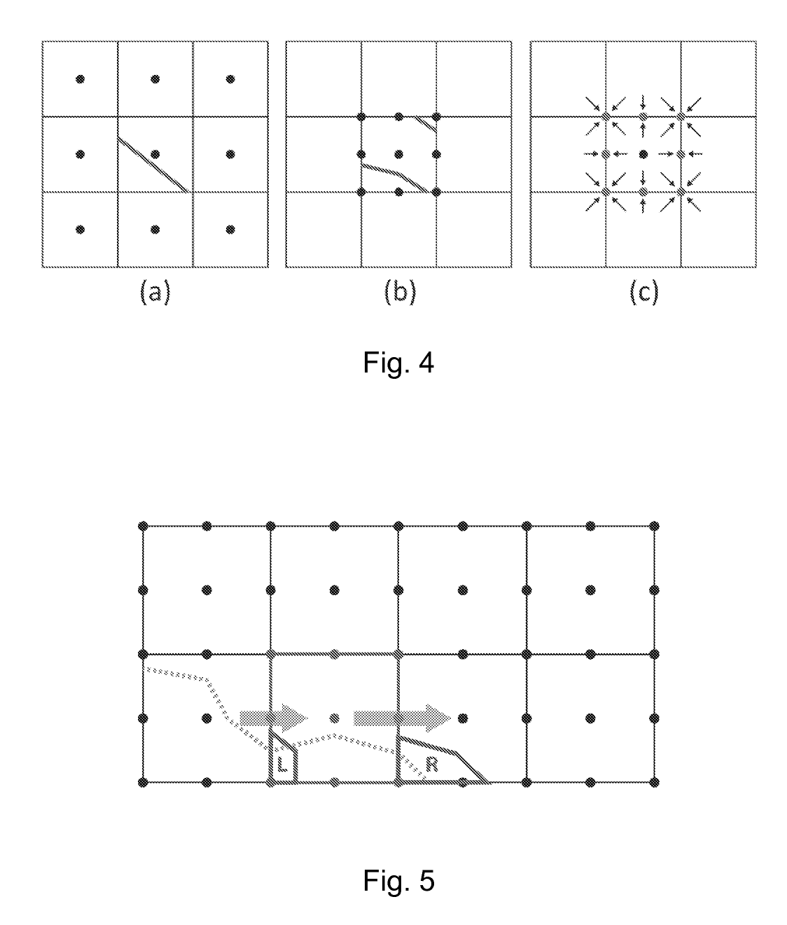

The main difference between the previous VOF or CLSVOF methods and ours comes from that, in our method, the level set values are stored at the refined points as shown in FIG. 4. If the refinement of a cell is made as suggested in [DP09, HK10], it is possible to reconstruct the level set function in the cell using Lagrange polynomials. We use the third-order Lobbato points.

Compared to solving the least squares problem using the 3×3 (3×3×3 in 3D) stencil [MTB07], with the cell refinement, the interface is directly reconstructed by the marching cube algorithm. Note that refinements of neighbour cells can provide different level set values (up to four values in 2D) to a shared refined point, as shown in FIG. 4 (c). In such a case, we basically take the absolute minimum value. In order to detect the shared points, we use the grid hashing.

### 5.2. Volume Computation

Coupling of the level set and the volume fraction requires an efficient volume computation method. We use the Heaviside function approximation formulas presented by [MG08]. (In Table 1, we fix two errata of the formulas). One can compute the volume by extracting the closed meshes, using the voxelization [ED08], or approximating the Heaviside function in other ways [Tow09]. However, the method we used is fast enough and sufficiently robust.

Also, it gives the exact volume for piecewise linear interfaces.

TABLE 1
We correct the two entries of the Heaviside
function approximation table of [MG08].

| φ₀ | φ₁ | φ₂ | φ₃ | H₀(φ₀, φ₁, φ₂, φ₃, P₀, P₁, P₂, P₃) |
|---|---|---|---|---|
| − | + | − | − | $\frac{V ( {P}_{0} {P}_{1} {P}_{2} {P}_{3} )}{4} - \frac{V ( {P}_{01} {P}_{1} {P}_{12} {P}_{13} )}{4} \frac{{φ}_{1}}{{φ}_{1} - {φ}_{0}}$ |
| − | + | + | + | $\frac{V ( {P}_{0} {P}_{01} {P}_{02} {P}_{03} )}{4} ( 1 + \frac{{φ}_{1}}{{φ}_{1} - {φ}_{0}} + \frac{{φ}_{2}}{{φ}_{2} - {φ}_{0}} + \frac{{φ}_{3}}{{φ}_{3} - {φ}_{0}} )$ |

### 5.3. Advection of Volume Fraction

The advection equation for the volume fraction is solved by the split-direction method; Equation 3 is discretized by Equation 11, which is integrated (in 2D) by Equations 12 and 13.

$$\begin{matrix}\frac{{T}^{n + \frac{1}{2}} - {T}^{n - \frac{1}{2}}}{Δ t} + ∇ \cdot ( {T}^{n} {u}^{n} ) = 0 & ( 11 ) \\ {T}_{ij}^{*} {V}_{ij}^{*} = {T}_{ij}^{n - \frac{1}{2}} {V}_{ij}^{n - \frac{1}{2}} + ( {F}_{i - \frac{1}{2} j}^{n - \frac{1}{2}} - {F}_{i + \frac{1}{2} j}^{n - \frac{1}{2}} ) & ( 12 ) \\ {T}_{ij}^{n + \frac{1}{2}} {V}_{ij}^{n + \frac{1}{2}} = {T}_{ij}^{*} {V}_{ij}^{*} + ( {F}_{ij - \frac{1}{2}}^{*} - {F}_{ij + \frac{1}{2}}^{*} ) & ( 13 )\end{matrix}$$

where V and F are the effective cell volume and the flux passing through a cell face. Since it is formulated by FVM, the total volume is preserved. Note that we truncate the volume fraction that is apart from the interface by h in order to handle flotsams caused by the lack of floating precision. However, the truncation effect on the volume conservation is small as shown in FIG. 9.

The flux at each cell face is computed geometrically, as shown in FIG. 5. When we compute the flux (in one direction), first, we compute the distance by multiplying the face velocity with time step size. Second, we take the level set of the intruding cell and fit it to the volume fraction (Section 5.5). Then, we cut the intruding cell by the distance and apply the Heaviside function approximation to find volume.

For the flux computation in the next direction, we move the level set of the original cell with the face velocity and store it temporarily.

### 5.4. Advection of the Level Set

After the advection of the volume fraction, we advect the level set using the semi-Lagrangian method. We use the Runge-Kutta second-order method for the position integration and use Lagrange polynomials for the level set interpolation as in [DP09, HK10].

### 5.5. Correction of the Level Set

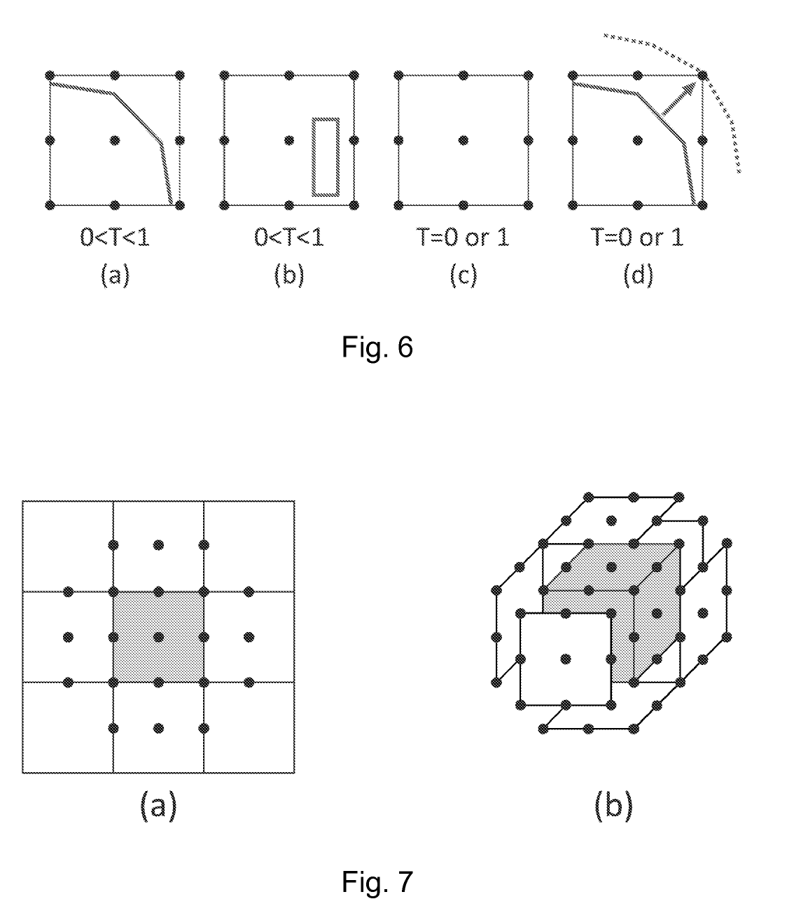

We correct the level set values in a cell to be consistent with the volume fraction. In order to preserve the interface details, we let all the level set values in the refined cell change by a constant c in Equation 14. The inverse problem to determine c given the target volume fraction T is solved by the Brent's method.

$${\int }_{Ω} H ( φ ) d Ω = {\int }_{Ω} H ( {\sum }_{i = 0}^{N - 1} {L}_{xyz}^{i} ( {φ}_{i} + c ) ) = TV , \qquad ( 14 )$$

where H is the Heaviside function defined on a cell Ω, Lⁱxyz is a Lagrange polynomial defined at the i-th level set point, and N is the number of level set points. If the target volume fraction is zero or one, the solution could not be unique. Therefore, we modified the Brent's method to give the unique solution by selecting the absolute minimum change c which makes all level set values have the same sign as in FIG. 6 (d). When we correct the level set values, neighbour cells which share a refined point may change its level set value differently. We let the point take the absolute minimum if all corrected values have the same sign. If there exists a corrected value of different sign, we let the point take the average.

FIG. 6 shows four cases of the level set volume correction. The case of (b) shows the inconsistency between the volume fraction and the level set. In this case, we have to handle two types of volume fractions: one is known to be flotsam and the other is a small feature aliased in the cell.

The first one is ignored whereas the second must be heeded.

To do this, we introduce the sub-cell volume element. We determine the center position of the sub-cell volume element by computing the inverse distance weighted average of the level set points. Given the volume fraction, we set the width, height, and depth of the element by considering the variances. Also, we define the sign of the element by the opposite sign of the level set. If the sub-cell volume element overlaps at least p/2 grid points with different signs, it changes the values of the overlapped level set points. (If we let the element change the level set value even when it overlaps only one grid point, the tiny interface can not move outside the cell and can be seen as a noise). We provide Algorithm 1 for the volume correction.

Algorithm 1 Volume Correction

```
while Leaf cells do
  if 0 < T < 1 and φ₁ have the same sign then
    Generate the sub-cell volume element
    If The element overlaps p/2 grid points then
      Change φ1s at the overlapped grid points
    end if
  end if
  if There exists a φ₁ of different sign then
    Fit φ to T
  end if
end while
```

This routine can be called in the process of the volume fraction advection. If the sub-cell volume element is generated during the process, it participates in the flux computation by moving, resizing, and destroying. However, we emphasize that it does not change the volume fraction itself, thus, it does not affect the volume conservation.

### 5.6. Redistancing

In the advection of the level set, the level set should satisfy the signed distance property. Since our CFL number is less than one, it is sufficient for the cells next to the interface to be of the signed distance property. We have implemented two different redistancing methods; one is PDE-based and the other is mesh-based.

In the PDE-based method, we use the sub-cell corrected ENO2 derivatives. Since we rely on the geometric distance to the interface, the overall accuracy is limited to the second order, thus, higher order method is redundant. We precompute the ENO constants and perform Gauss-Seidel sweeping as [Min10]. The sweeping directions on the octree is determined by the order of traversing children nodes as [COQ06].

Alternatively, we can compute the signed distance directly from the meshes extracted from the level set grid. If we make a map from each cell to its adjacent triangles of the meshes priorly, the computation can be accelerated. Compared to the PEE-based method, the mesh-based method is easily parallelized. At the same time, the result is almost the same. Hence, we have used the mesh-based method for all experiments.

### 5.7. Surface Tension

To model surface tension, we use the continuum based surface tension force (CSF) [BKZ92]. For the curvature computation, we adopt the least squares method suggested by [MR06], which relaxes the locality of the curvature.

$$[ \begin{matrix}1 & Δ {x}_{1} & Δ {y}_{1} & Δ {z}_{1} & \frac{1}{2} Δ {x}_{1}^{2} & \frac{1}{2} Δ {y}_{1}^{2} & Δ {x}_{1} Δ {y}_{1} & Δ {x}_{1} Δ {z}_{1} & Δ {y}_{1} Δ {z}_{1} \\ ⋮ & ⋮ & ⋮ & ⋮ & ⋮ & ⋮ & ⋮ & ⋮ & ⋮ \\ 1 & Δ {x}_{N} & Δ {y}_{N} & Δ {z}_{N} & \frac{1}{2} Δ {x}_{N}^{2} & \frac{1}{2} Δ {y}_{N}^{2} & Δ {x}_{N} Δ {y}_{N} & Δ {x}_{N} Δ {z}_{N} & Δ {y}_{N} Δ {z}_{N}\end{matrix} ] [ \begin{matrix}φ \\ {\partial }_{x} φ \\ {\partial }_{y} φ \\ {\partial }_{z} φ \\ {\partial }_{xx} φ \\ {\partial }_{yy} φ \\ {\partial }_{zz} φ \\ {\partial }_{xy} φ \\ {\partial }_{xz} φ \\ {\partial }_{yz} φ\end{matrix} ] = [ \begin{matrix}φ ( {x}_{1} ) \\ ⋮ \\ φ ( {x}_{N} )\end{matrix} ] \qquad ( 15 )$$

where the system is formulated by N sample points and the solution is used to compute the curvature. To solve Equation 15 properly, we need at least 6 (10) sample points in 2D (3D). In our implementation, we use 21 (81) sample points in 2D (3D) as illustrated in FIG. 7. We precompute the inverse matrix of the normal equation for the efficiency.

It has been reported that in simulations of two phase flows dominated by surface tension, methods considering sub-cell level details often fail (even if the curvature is accurate) [DP09, WMFB11]. The resolution mismatch between the momentum grid and the interface grid can cause the imbalance between the pressure difference and the surface tension across the interface. These errors are accumulated and become sources of spurious currents which deform the interface abnormally. Therefore, we pay attention to the balance of the pressure difference and the surface tension in two ways: first, we compute the surface tension at the cell face (as we did for the pressure projection) and apply it to the cell center [Pop09]. Second, we optionally apply the smoothing filter [Tau95] to local meshes before the volume correction if flows are dominated by the surface tension. In these ways, we can practically reduce the spurious currents near the interfaces and increase the stability.

### 6. Results

All simulations presented here were performed on a single desktop computer with Intel Core i7 3.3 GHz CPU with 12 GB RAM on 64 bit windows OS. We accelerated our framework using MPICH. The optimization techniques for the domain decomposition have not been implemented, thus, linear scalability was not accomplished. However, the optimization is one of our future works. The final rendering was done with Mitsuba [Jak10]. For the density and viscosity, we used ρl=999 kg/m3 and μl=1.1e−3 kg/ms for the water, ρg=1.2 kg/m3 and μg=1.8e−5 kg/ms for the air. We used the surface tension coefficient σ=7.2e−2 Nm and the gravity g=9.8 m/s2.

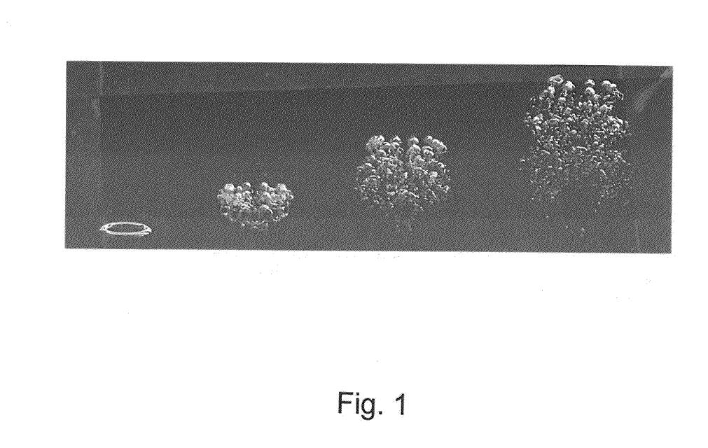

FIG. 1 shows four snapshots taken during a GAVOF simulation, in which an air ring breaks into deforming bubbles by the buoyant force. We decomposed the domain into 3×3×1 and used the resolution 643 for each decomposed domain. The physical, size of the domain is 45 cm×45 cm×15 cm. Using nine cores, each time step took about 1.5 minute. Without using any kind of Lagrangian particles or artificial forces, the experiment demonstrates that the proposed method successfully generates various scales and shapes of bubbles, without dissipating as they rise up.

FIG. 9 plots volume profiles for all 3D simulations. It shows that the volume is well preserved. For example, the volume change of the air ring is less than 2% although the air ring occupies only 0.16% volume in the domain.

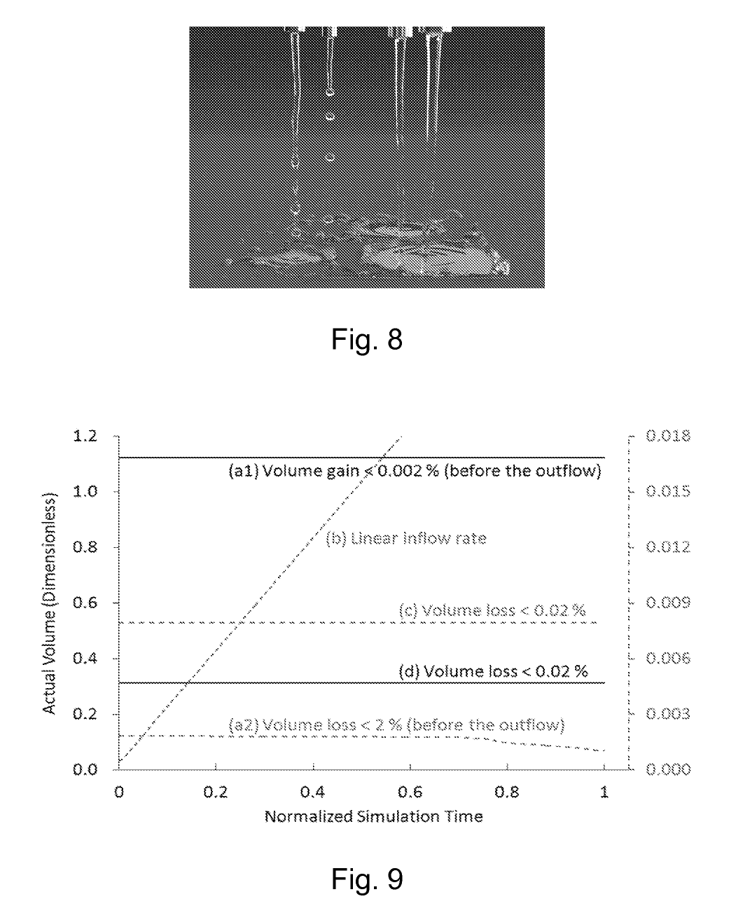

FIG. 8 shows a snapshot of another GAVOF simulation in which four columns of water with different thicknesses are falling down. The water does not disappear, but piles up on the floor. Interestingly, we can observe that the simulator generates the Plateau-Rayleigh instability caused by the surface tension. We decomposed the domain into 23 and used the resolution 643 for each decomposed domain. The physical size of the domain was 10 cm×10 cm×10 cm. Using eight cores, each time step took about one minute.

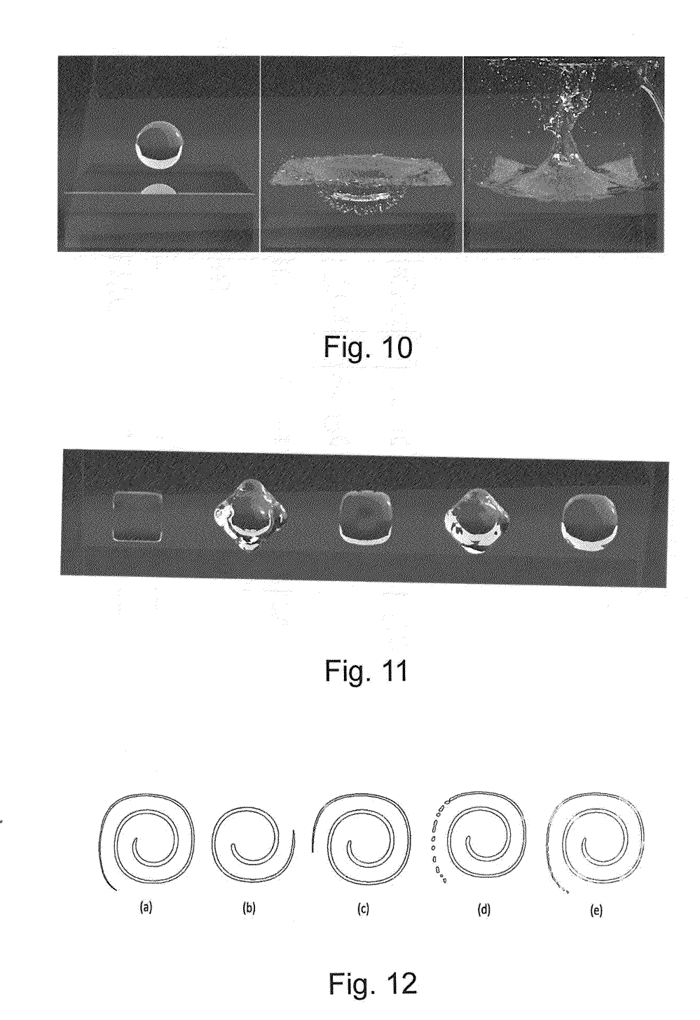

FIG. 10 shows snapshots of the third GAVOF simulation in which a water ball drops into a body of water. The video shows that air bubbles are entrapped naturally at the contact and do not dissipate. We used the resolution 128̂3 for the entire domain. The physical size of the domain was 30 cm×30 cm×30 cm. We decomposed the domain into four sub-domains. Using four cores, each time step took about two minutes. In this simulation, non-separating boundary artefacts are shown. Applying robust solid boundary handling methods such as [MST10, CM11], to GAVOF is one of our future works.

### 7. Conclusion

In this paper, we have presented a new framework to simulate moving interfaces in viscous incompressible two phase flows without loss of the fluid volume and surface details. The sub-grid refinement of the level set coupled with the VOF method could improve the previous coupling methods by capturing sub-cell details more vividly.

A limitation of our method is the time step restriction. It is known that the surface tension can induce spurious currents near the interface and become unstable when large time steps are used. Stable methods to alleviate this problem have been introduced by [SO09, Sus11]. Applying these methods to our framework will be a future work. Our framework is not limited to the regular grid. Hence, the application to irregular domains can be another future work.

### 8. Acknowledgements

We would like to thank Dr. Doyub Kim, Dr. Nambin Heo, and the anonymous reviewers for their valuable discussions for this work. This work was supported by Ministry of Culture, Sports and Tourism (MCST) and Korea Culture Content Agency (KOCCA) in the Culture Technology (CT) Research & Development Programs 2013, National Research Foundation of Korea (NRF) grant funded by the Korea government (MEST) (No. 2012R1A2A1A01004891), the Brain Korea 21 Project in 2013, and ASRI (Automation and Systems Research Institute at Seoul National University).

### REFERENCES

[AIA 12] AKINCI N., IHMSEN M., AKINCI G., SOLENTHALER B., TESCHNER M.: Versatile rigid-fluid coupling for incompressible SPH. ACM Trans. Graph. 31, 4 (July 2012), 62:1-62:8. 2
[APKG07] ADAMS B., PAULY M., KEISER R., GUIBAS L. J.: Adaptively sampled particle fluids. ACM Trans. Graph. 26, 3 (2007), 48. 2
[AT11] ANDO R., TSURUNO R.: A particle-based method for preserving fluid sheets. In Proceedings of the 2011 ACM SIGGRAPH/Eurographics Symposium on Computer Animation (2011), ACM, pp. 7-16. 3
[BB12] BOYD L., BRIDSON R.: MultiFLIP for energetic two-phase fluid simulation. ACM Trans. Graph. 31, 2 (Apr. 2012), 16:1-16:12. 3
[BBB10] BROCHU T., BATTY C., BRIDSON R.: Matching fluid simulation elements to surface geometry and topology. ACM Trans. Graph. 29 (July 2010), 47:1-47:9. 3
[BCG89] BELL J., COLELLA P., GLAZ H.: A second-order projection method for the incompressible Navier-Stokes equations. J. Comp. Phys. 85 (1989), 257-283. 4
[BGOS06] BARGTEIL A. W., GOKTEKIN T. G., O'BRIEN J. F., STRAIN J. A.: A semi-Lagrangian contouring method for fluid simulation. ACM Trans. Graph. 25, 1 (2006), 19-38. 3
[BKZ92] BRACKBILL J. U., KOTHE D. B., ZEMACH C.: A continuum method for modeling surface tension. J. Comp. Phys. 100 (1992), 335-354. 6
[BT07] BECKER M., TESCHNER M.: Weakly compressible SPH for free surface flows. In Proceedings of the 2007 ACM SIGGRAPH/Eurographics Symposium on Computer Animation (2007), Eurographics Association, pp. 209-217. 2
[Cho67] CHORIN A. J.: A numerical method for solving incomressible viscous flow problems. J. Comp. Phys. 2 (1967), 12-26. 2
[CM11] CHENTANEZ N., MÜLLER M.: A multigrid fluid pressure solver handling separating solid boundary conditions. In Proceedings of the 2011 ACM SIGGRAPH/Eurographics Symposium on Computer Animation (2011), ACM, pp. 83-90. 7
[CM12] CHENTANEZ N., MÜLLER M.: Mass-conserving eulerian liquid simulation. In Proceedings of the ACM SIGGRAPH/Eurographics Symposium on Computer Animation (2012), Eurographics Association, pp. 245-254. 2
[COQ06] CECIL T. C., OSHER S. J., QIAN J.: Simplex free adaptive tree fast sweeping and evolution methods for solving level set equations in arbitrary dimension. J. Comp. Phys. 213 (2006), 458-473. 6
[CPPK07] CLEARY P. W., PYO S. H., PRAKASH M., KOO B. K.: Bubbling and frothing liquids. ACM Trans. Graph. 26, 3 (2007), 97. 2
[DP09] DESJARDINS O., PITSCH H.: A spectrally refined interface approach for simulating multiphase flows. J. Comput. Phys. 228, 5 (2009), 1658-1677. 4, 5, 7
[ED08] EISEMANN E., DÉCORET X.: Single-pass GPU solid voxelization and applications. In Proceedings of graphics interface 2008 (2008), pp. 78-80. 5
[EMF02] ENRIGHT D., MARSCHNER S., FEDKIW R.: Animation and rendering of complex water surfaces. ACM Trans. Graph. 21, 3 (2002), 736-744. 2, 3
[HK10] HEO N., KO H.-S.: Detail-preserving fully-Eulerian interface tracking framework. ACM Trans. Graph. 29 (December 2010), 176:1-176:8. 2, 4, 5
[HLYK08] HONG J.-M., LEE H.-Y., YOON J.-C., KIM C.-H.: Bubbles alive. ACM Trans. Graph. 27, 3 (2008), 1-4. 3
[HN81] HIRT C. W., NICHOLS B. D.: Volume of fluid (VOF) method for the dynamics of free boundaries. J. Comp. Phys. 39 (1981), 201-225. 2
[IAAT12] IHMSEN M., AKINCI N., AKINCI G., TESCHNER M. : Unified spray, foam and air bubbles for particle-based fluids. The Visual Computer 28, 6-8 (June 2012), 669-677. 2
[Jak10] JAKOB W.: Mitsuba renderer, 2010. http://www.mitsubarenderer.org. 7
[KLL*07] KIM B., LIU Y., LLAMAS I., JIAO X., ROSSIGNAC J.: Simulation of bubbles in foam with the volume control method. ACM Trans. Graph. 26, 3 (2007), 98. 2
[KPNS10] KANG N., PARK J., NOH J., SHIN S. Y.: A hybrid approach to multiple fluid simulation using volume fractions. Computer Graphics Forum 29 (2010) 685-694. 2
[KSK09] KIM D., SONG O.-Y., KO H.-S.: Stretching and wiggling liquids. ACM Trans. Graph. 28, 5 (2009), 1-7. 2
[KSK10] KIM D., SONG O.-Y., KO H.-S.: A practical simulation of dispersed bubble flow. ACM Trans. Graph. 29 (July 2010), 70:1-70:5. 3
[LCPF12] LENTINE M., CONG M., PATKAR S., FEDKIW R.: Simulating free surface flow with very large time steps. In Proceedings of the ACM SIGGRAPH/Eurographics Symposium on Computer Animation (2012), Eurographics Association, pp. 107-116. 2
[LGF04] LOSASSO F., GIBOU F., FEDKIW R.: Simulating water and smoke with an octree data structure. ACM Trans. Graph. 23, 3 (2004), 457-462. 2, 4
[LGF11] LENTINE M., GRÉTARSSON J. T., FEDKIW R. An unconditionally stable fully conservative semi-Lagrangian method. J. Comp. Phys. 230 (2011), 2857-2879. 2
[LTKF08] LOSASSO F., TALTON J., KWATRA N., FEDKIW R.: Two-way coupled SPH and particle level set fluid simulation. IEEE Transactions on Visualization and Computer Graphics 14, 4 (2008), 797-804. 3
[M0″ 9] MÜLLER M.: Fast and robust tracking of fluid surfaces. In Proceedings of the 2009 ACM SIGGRAPH/Eurographics Symposium on Computer Animation (2009), ACM, pp. 237-245. 3
[MCG03] MÜLLER M., CHARYPAR D., GROSS M.: Particle-based fluid simulation for interactive applications. In Proceedings of the 2003 ACM SIGGRAPH/Eurographics Symposium on Computer Animation (2003), pp. 154-159. 2
[MG07] MIN C., GIBOU F.: A second order accurate level set method on non-graded adaptive Cartesian grids. J. Comput. Phys. 225 (July 2007), 300-321. 4
[MG08] MIN C., GIBOU F.: Robust second-order accurate discretizations of the multi-dimensional Heaviside and Dirac delta functions. J. Comp. Phys. 227 (2008), 9686-9695. 5
[Min10] Min C.: On reinitializing level set functions. Ju Comp. Phys. 229 (2010), 2764-2772. [MMS09] MIHALEF V., METAXAS D., SUSSMAN M.: Simulation of two-phase flow with sub-scale droplet and bubble effects. Comput. Graph. Forum 28, 2 (2009), 229-238. 3
[MMTD07] MULLEN P., MCKENZIE A., TONG Y., DESBRUN M.: A variational approach to Eulerian geometry processing. ACM Trans. Graph. 26, 3 (2007), 66. 2
[Mon92] MONAGHAN J. J.: Smoothed particle hydrodynamics. Ann. Rev. Astron. Astrophys. 30 (1992), 543-74. 2
[MR06] MARCHANDISE E., REMACLE J.-F.: A stabilized finite element, method using a discontinuous level set approach for solving two phase incompressible flows. J. Comput. Phys. 219, 2 (2006), 780-800. 6
[MST10] MCADAMS A., SIFAKIS E., TERAN J.: A parallel multigrid poisson solver for fluids simulation on large grids. In Proceedings of the 2010 ACM SIGGRAPH/Eurographics Symposium on Computer Animation (2010), Eurographics Association, pp. 65-74. 7
[MTB07] MÉNARD T., TANGUY S., BERLEMONT A.: Coupling level set/VOF/ghost fluid methods: Validation and application to 3D simulation of the primary break-up of a liquid jet. Journal of Multiphase Flow 33 (2007), 510-524. 5, 9
[MUM*06] MIHALEF V., UNLUSU B., METAXAS D., SUSSMAN M., HUSSAINI M. Y.: Physics based boiling simulation. In Proceedings of the ACM SIGGRAPH/Eurographics Symposium on Computer Animation (2006), pp. 317-324. 2
[OS88] OSHER S., SETHIAN J. A.: Fronts propagating with curvature-dependent speed: Algorithms based on hamilton-jacobi formulations. J. Comp. Phys. 79 (1988), 12-49. 2
[Pop03] POPINET S.: Gerris: a tree-based adaptive solver for the incompressible Euler equations in complex geometries. J. Comp. Phys. 228 (2003), 572-600. 2, 3, 4
[Pop09] POPINET S.: An accurate adaptive solver for surface tension-driven interfacial flows J. Comp. Phys. 228 (2009), 5838-5866. 7
[PTB*03] PREMOZE S., TASDIZEN T., BIGLER J., LEFOHN A. E., WHITAKER R. T.: Particle-based simulation of fluids. Comput. Graph. Forum 22, 3 (2003), 401-410. 2
[RK98] RIDER W. J., KOTHE D. B.: Reconstructing volume tracking. J. Comput. Phys. 141 (1998), 112-152. 2
[RS00] RUSSO G., SMEREKA P.: A remark on computing distance functions. J. Comput. Phys. 163 (September 2000), 51-67. 2
[SG11] SOLENTHALER B., GROSS M.: Two-scale particle simulation. ACM Trans. Graph. 30 (August 2011), 81:1-81:8. 2
[SKK07] SONG O.-Y., KIM D., KO H.-S.: Derivative particles for simulating detailed movements of fluids. IEEE Transactions on Visualization and Computer Graphics 13, 4 (2007), 711-719. 2, 3
[SO09] SUSSMAN M., OHTA M.: A stable and efficient method for treating surface tension in incompressible two-phase flow. SIAM J. Sci. Compute 31, 4 (June 2009), 2447-2471. 8
[SP00] SUSSMAN M., PUCKETT E. G.: A coupled level set and volume-of-fluid method for computing 3D and axisymmetric incompressible two-phase flows. J. Comp. Phys. 162 (2000), 301-337. 2
[SP09] SOLENTHALER B., PAJAROLA R.: Predictive-corrective incompressible SPH. ACM Trans. Graph. 28, 3 (2009), 1-6. 2
[SSO94] SUSSMAN M., SMEREKA P., OSHER S.: A level set approach for computing solutions to incompressible two-phase flow. J. Comput. Phys. 114, 1 (1994), 146-159. 2
[Sta99] STAM J.: Stable fluids. Computer Graphics (Proc. ACM SIGGRAPH '99) 33, Annual Conference Series (1999), 121-128. 2
[Sus11] SUSSMAN M.: A method for overcoming the surface tension time step constraint in multiphase flows ii. Int. J. Numer. Meth. Fluids 68 (2011), 1343-1361. 8
[Tau95] TAUBIN G.: A signal processing approach to fair surface design. In Proceedings of the 22nd annual conference on Computer graphics and interactive techniques (1995), SIGGRAPH '95, ACM, pp. 351-358. 7, 8
[Tow09] TOWERS J. D.: Finite difference methods for approximating Heaviside functions. J. Comp. Phys. 228 (2009), 3478-3489. 5
[TWGT10] THÜREY N., WOJTAN C., GROSS M., TURK G.: A multiscale approach to mesh-based surface tension flows. ACM Trans. Graph. 29, 4 (July 2010), 48:1-48:10. 3
[WMFB11] WOJTAN C., MÜLLER-FISCHER M., BROCHU T.: Liquid simulation with mesh-based surface tracking. In ACM SIGGRAPH 2011 Courses (2011), SIGGRAPH '11, ACM, pp. 8:1-8:84. 7
[WTGT09] WOJTAN C., THÜREY N., GROSS M., TURK G.: Deforming meshes that split and merge. ACM Trans. Graph. 28, 3 (2009), 1-10. 3
[WTG10] WOJTAN C., THÜREY N., GROSS M., TURK G.: Physics-inspired topology changes for thin fluid features. ACM Trans. Graph. 29, 4 (2010), 1-8. 3
[YT10] YU J., TURK G.: Reconstructing surfaces of particle-based fluids using anisotropic kernels. In Proceedings of the 2010 ACM SIGGRAPH/Eurographics Symposium on Computer Animation (2010), Eurographics Association, pp. 217-225. 2
[YWTY12] YU J., WOJTAN C., TURK G., YAP C.: Explicit mesh surfaces for particle based fluids. EUROGRAPHICS 2012 30 (2012), 41 -48. 2
[ZB05] ZHU Y., BRIDSON R.: Animating sand as a fluid. ACM Trans. Graph. 24, 3 (2005), 965-972. 2, 3

What is claimed is:

1. A method of simulation of moving interfaces using geometry-aware volume-of-Fluid method, the method comprising steps for:
representing two different fluid volumes in a domain using a level set surface on a grid mesh comprising a plurality of cells;
representing an interface with a zero contour of a level set function;
modeling two phase flow dynamics of the two different fluid volumes using a viscous incompressible Navier-Stokes equations with surface tension;
updating incompressible velocity field of the domain by computing a velocity advection term in a conservative manner, performing a velocity diffusion implicitly, performing a pressure projection with surface tension, and applying a pressure difference to make an intermediate velocity incompressible;
updating the interface using the incompressible velocity field by updating a volume fraction of each cell in a conservative manner, moving the level set interface using a semi-Lagrangian method, correcting a resulting level set interface according to the volume fraction, and performing redistancing of the level set; and
displaying the updated interface of the two fluid volumes on a display,
wherein the level set values are stored in refined sub-grids,
wherein in order to correct level set values in a cell to be consistent with the volume fraction a sub-cell volume element is generated and used.

2. The method of claim 1, wherein the viscous incompressible Navier-Stokes equations with surface tension comprises
$$\begin{matrix}\text{?} & Eq . 1 \\ \text{?} & Eq . 2 \\ \text{?} & Eq . 3 \\ \text{?} & Eq . 4 \\ \text{?} , & Eq . 5 \\ \text{?} \text{indicates text missing or illegible when filed} & \end{matrix}$$
where u, ρ, μ, p, D, σ, κ, δₛ, n, and g stand for velocity, density, dynamic viscosity, pressure, deformation rate tensor, surface tension coefficient, curvature, Dirac delta function defined on the interface, unit normal to the interface, and gravity, respectively, T is a volume fraction, and φ is the level set, wherein 0≦T≦1.

3. The method of claim 2, further comprising steps for:
computing the density and the dynamic viscosity using
$$\begin{matrix}\text{?} & Eq . 5 \\ \text{?} ; and & Eq . 6 \\ \text{?} \text{indicates text missing or illegible when filed} & \end{matrix}$$
computing the curvature using
$$\begin{matrix}\text{?} . & Eq . 7 \\ \text{?} \text{indicates text missing or illegible when filed} & \end{matrix}$$

4. The method of claim 2, wherein the grid mesh comprises a restrictive and fully-threaded octree.

5. The method of claim 2, further comprising a step for integrating time using a modified fractional step method (FSM) such as [symbol]
FIG. 3
where the superscript n+½ denotes a time step right after the step of updating the interface, F is a linear operator, and G is a weighted Laplace operator produced by the pressure projection,
wherein the linear systems represented by F and G are solved by using a Poisson equation solver.

6. The method of claim 2, further comprises a step for coupling the level set and the volume fraction by a volume computation such as a Heaviside function approximation formulas.

7. The method of claim 6, wherein an advection of the volume fraction is performed by Eq. 3, which is discretized by Eq. 11,
$$\begin{matrix}\text{?} & Eq . 11 \\ \text{?} \text{indicates text missing or illegible when filed} & \end{matrix}$$
wherein Eq. 11 is integrated by Eqs. 12 and 13 for two (2)-dimensional domain
$$\begin{matrix}\text{?} & Eq . 12 \\ \text{?} . & Eq . 13 \\ \text{?} \text{indicates text missing or illegible when filed} & \end{matrix}$$

8. The method of claim 7, wherein after the advection of the volume advection an advection of the level set is performed by a semi-Lagrangian method such as a Runge-Kutta second-order method.

9. The method of claim 6, wherein in correcting the level set values in a cell to be consistent with the volume fraction all the level set values in the refined cell are changed by a constant c of Eq. 14,
$$\begin{matrix}\text{?} , & Eq . 14 \\ \text{?} \text{indicates text missing or illegible when filed} & \end{matrix}$$
wherein the constant c for a given target volume fraction T is determined by a Brent's method.

10. The method of claim 9, wherein a center position of the sub-cell volume element is determined by computing an inverse distance weighted average of level set points.

11. The method of claim 10, wherein the advection of the volume fraction further comprises a volume correction given by [symbol]
Algorithm 1.

12. The method of claim 1, wherein the redistancing is performed by computing a signed distance directly from meshes extracted from the level set grid.
